(19) United States
(12) Patent Application Publication
(10) Pub. No.: US 2026/0255254 A1
(43) Pub. Date: Aug. 27, 2026

(54) METHODS AND APPARATUSES FOR INDICATING AND APPLYING INFORMATION ASSOCIATED WITH PLMN

(71) Applicant: LENOVO (BEIJING) LIMITED, Beijing (CN)

(72) Inventors: Min XU, Beijing (CN); Lianhai WU, Beijing (CN); Ran YUE, Beijing (CN); Jing HAN, Beijing (CN); Jie HU, Beijing (CN)

(21) Appl. No.: 18/994,252

(22) PCT Filed: Jul. 15, 2022
(86) PCT No.: PCT/CN2022/105953

§ 371 Date: Jan. 14, 2025

(51) Int. Cl. H04W 48/04; H04W 48/16; H04W 84/04

(52) U.S. Cl. CPC H04W 48/04; H04W 48/16; H04W 84/042

(57) ABSTRACT

The present application relates to methods and apparatuses for indicating and applying information associated with one or more PLMNs forbidden to operate at a present location of the UE. An embodiment of the present disclosure provides a user equipment (UE), comprising: an AS; and a NAS, wherein the NAS is configured to: determine whether at least one trigger condition of one or more trigger conditions for transmitting information associated with one or more public land mobile networks (PLMN) forbidden to operate at a present location of the UE is fulfilled; and transmit the information to the AS in response to fulfillment of at least one of the one or more trigger conditions.

### TECHNICAL FIELD

The present disclosure relates to wireless communication technology, and more particularly, relates to methods and apparatuses for indicating and applying information associated with one or more public land mobile networks (PLMN) forbidden to operate at a present location of the user equipment (UE).

### BACKGROUND OF THE INVENTION

A non-terrestrial network (NTN) refers to a network, or segment of networks, which use radio frequency resources on board a spaceborne vehicle or an airborne vehicle for transmission (e.g., a satellite). For example, the satellite in an NTN may be a geostationary Earth orbiting (GEO) satellite with fixed location to the Earth, or a low Earth orbiting (LEO) satellite orbiting around the Earth.

In some cases with satellite access, such as NTN, mobile network services can be provided through radio access technologies. The coverage of an NTN may extend far beyond the political borders of countries wherein regulations of communication services may be different. An NTN cell, which is formed by one or multiple satellite beams, may cover a much larger area (for example, an area with a radius of hundreds of kilometers) than that of a terrestrial network (TN). In some scenarios, an NTN cell may cover an area larger than an area of a country. However, an NTN may not be allowed to provide service to users in a certain country or at a certain location due to regulation or security reasons, such as when the coverage of an NTN cell crosses national boundaries. That is, a PLMN may not be allowed to operate at in a certain country, or be accessed by UEs within the certain country.

Accordingly, it is advantageous to provide solutions for indicating and applying information associated with one or more PLMNs forbidden to operate at a present location of the UE.

### SUMMARY

An embodiment of the present disclosure provides a user equipment (UE), comprising: an AS; and a NAS, wherein the NAS is configured to: determine whether at least one trigger condition of one or more trigger conditions for transmitting information associated with one or more public land mobile networks (PLMN) forbidden to operate at a present location of the UE is fulfilled; and transmit the information to the AS in response to fulfillment of at least one of the one or more trigger conditions.

In some embodiments, the information includes at least one of the following: an identity of a PLMN that is not allowed to operate at a present location of the UE; a location of the UE where the UE receives a rejection from a PLMN indicating that the PLMN is not allowed to operate at the location of the UE; validity time associated with one or more PLMNs in a list of PLMNs and associated epoch time; remaining validity time duration associated with one or more PLMNs in the list; distance thresholds associated with one or more PLMNs in the list and associated reference locations; an update of the list of PLMNs; or an indication indicating reporting only allowed PLMNs.

In some embodiments, the one or more trigger conditions includes at least one of the following: one or more PLMNs being added to a list of PLMNs; one or more PLMNs being removed from the list; information associated with one or more PLMNs being updated; a PLMN selection procedure; a PLMN reselection procedure; a request for the information from the UE AS; or a periodic timer for transmitting the information being expired.

In some embodiments, the NAS is further configured to: receive one or more PLMNs associated with a first number of cells or a second number of cells from the AS, wherein a cell with a strongest signal strength is associated with a PLMN not allowed to operate at a present location of the UE based on the information, wherein each of the first number of cells is with a signal strength higher than a threshold, and wherein each of the second number of cells is with a signal strength lower than the strongest signal strength and higher than a signal strength of any unselected cells.

Another embodiment of the present disclosure provides a UE, comprising: an AS; and a NAS, wherein the AS is configured to: receive, from the NAS, information associated with one or more PLMN forbidden to operate at a present location of the UE; and perform at least one of the following based on the information: perform PLMN selection or PLMN cell reselection; perform cell selection or cell reselection; enable cell searching or cell measurement; or disable cell searching or cell measurement.

In some embodiments, the information includes at least one of the following: an identity of a PLMN that is not allowed to operate at a present location of the UE; a location of the UE where the UE receives a rejection from a PLMN indicating that the PLMN is not allowed to operate at the location of the UE; validity time associated with one or more PLMNs in a list of PLMNs and associated epoch time; remaining validity time duration associated with one or more PLMNs in the list; distance thresholds associated with one or more PLMNs in the list and associated reference locations; an update of the list of PLMNs; or an indication indicating reporting only allowed PLMNs.

In some embodiments, the AS is further configured to: transmit, to the NAS, a request for the information at one of the following occasions: neighbour cell measurement for cell reselection is triggered; cell searching for cell selection is triggered; cell ranking is triggered; a cell is selected; or a cell is reselected.

In some embodiments, performing PLMN selection or PLMN cell reselection includes: in the case that a cell with a strongest signal strength is associated with a PLMN not allowed to operate at a present location of the UE based on the information, select a first number of cells each with a signal strength higher than a threshold, or select a second number of cells with signal strengths lower than the strongest signal strength and higher than a signal strength of any unselected cells; and transmitting one or more PLMNs associated with the first number of cells or the second number of cells to the NAS.

In some embodiments, performing PLMN selection or PLMN cell reselection includes: selecting one or more PLMNs based on at least one of the following: distance thresholds associated with the one or more PLMNs; time thresholds associated with the one or more PLMNs; or an indication indicating reporting all found PLMNs.

In some embodiments, the one or more PLMNs precludes a first PLMN in at least one of the following cases: a distance from a present location of the UE to a reference location associated with the first PLMN does not exceed a distance threshold of the first PLMN; or a time duration from a current time to an epoch time associated with the first PLMN to does not exceed a time threshold of the first PLMN.

In some embodiments, the one or more PLMNs includes a second PLMN in at least one of the following cases: a distance from a present location of the UE to a reference location associated with the second PLMN exceeds a distance threshold of the second PLMN; or a time duration from a current time to an epoch time associated with the second PLMN to exceeds a time threshold of the second PLMN.

In some embodiments, in the case that the information indicates a PLMN associated with a serving cell of the UE is not allowed to operate at a present location of the UE, the AS is further configured to perform at least one of the following: trigger neighbour cell measurement; perform cell selection or cell reselection to a cell associated with a PLMN that is allowed to operate at a present location of the UE; or enter an IDLE mode.

In some embodiments, performing cell selection or cell reselection includes at least one of the following: precluding a cell associated with a PLMN that is not allowed to operate at a present location of the UE according to the information; or determining a cell associated with a PLMN that is allowed to operate at a present location of the UE as a candidate cell according to the information.

In some embodiments, disabling cell searching or cell measurement includes: disabling all cell searching or cell measurement in the case that all neighbour cell(s) of the UE is associated with one or more PLMNs that are not allowed to operate at a present location of the UE according to the information.

In some embodiments, enabling cell searching or cell measurement: enabling cell searching or cell measurement in the case that one or more neighbour cells associated with one or more PLMNs allowed to operate at a present location of the UE according to the information.

Yet another embodiment of the present disclosure provides a method, comprising: determining whether at least one trigger condition of one or more trigger conditions for transmitting information associated with one or more PLMN forbidden to operate at a present location of a UE is fulfilled; and transmitting the information in response to fulfillment of at least one of the one or more trigger conditions.

Still another embodiment of the present disclosure provides a method, comprising: receiving information associated with one or more PLMN forbidden to operate at a present location of a UE; and performing at least one of the following based on the information: performing PLMN selection or PLMN cell reselection; performing cell selection or cell reselection; enabling cell searching or cell measurement; or disabling cell searching or cell measurement.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a scenario where a PLMN is not allowed to operate at the present UE location according to some embodiments of the present disclosure.

FIG. 3 illustrates a flow chart of transmitting the information associated with one or more PLMNs forbidden to operate at a present location of the UE from the NAS to the AS according to some embodiments of the present disclosure.

FIG. 4 illustrates a method performed by a NAS for transmitting the information associated with one or more PLMNs forbidden to operate at a present location of the UE from the NAS to the AS according to some embodiments of the present disclosure.

FIG. 5 illustrates a method performed by an AS applying the information associated with one or more PLMNs forbidden to operate at a present location of the UE from the NAS to the AS according to some embodiments of the present disclosure.

FIG. 6 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as the 3^{rd} generation partnership project (3GPP) 3G, LTE, LTE-Advanced (LTE-A), 3GPP 4G, 3GPP 5G NR, 3GPP Release 16 and onwards, a satellite communications network, a high altitude platform network, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

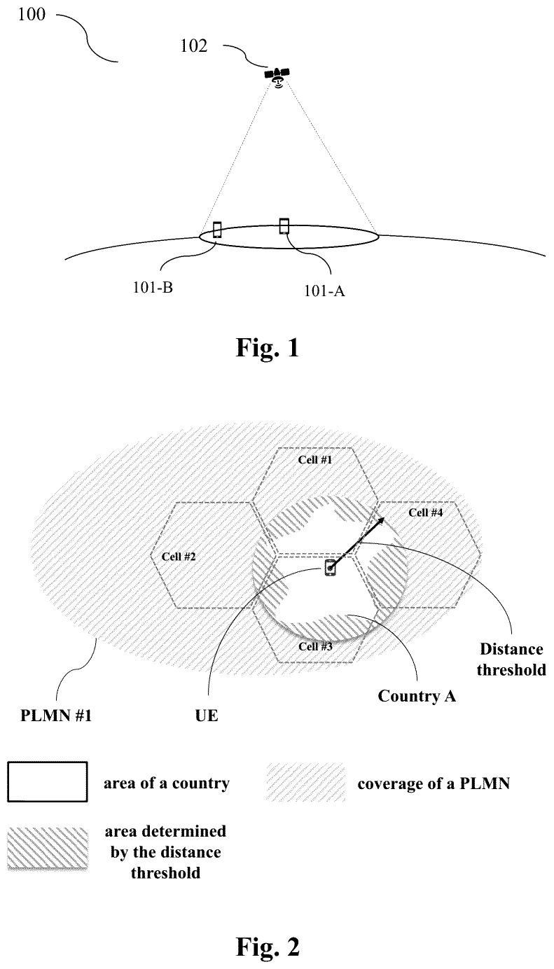

FIG. 1 illustrates a schematic diagram of a wireless communication system 100 in accordance with some embodiments of the present application.

As shown in FIG. 1, the wireless communication system 100 includes two UEs, UE 101-A and UE 101-B, and a BS 102, for example, a satellite BS. Although merely one BS is illustrated in FIG. 1 for simplicity, it is contemplated that the wireless communication system 100 may include more BSs in some other embodiments of the present application. Similarly, although merely two UEs are illustrated in FIG. 1 for simplicity, it is contemplated that the wireless communication system 100 may include more UEs in some other embodiments of the present application.

The BS 102 may also be referred to as an access point, an access terminal, a base, a macro cell, a node-B, a radio access network (RAN) node, an enhanced node B (eNB), a gNB, a home node-B, a relay node, or a device, or described using other terminology used in the art. The BS 102 is generally part of a radio access network that may include a controller communicably coupled to the BS 102.

The UE 101-A may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 101-A may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 101-A may include wearable devices, such as smart watches, fitness bands, optical head-mounted displays, or the like. Moreover, the UE 101-A may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

As mentioned above, a PLMN may not be able to operate at certain locations, and a list of “PLMNs not allowed to operate at the present UE location” at UE non-access stratum (NAS) is introduced. In this list, for each PLMN, there may be information related to whether or not the PLMN is allowed within a certain area. For example, the identity of the PLMN and the location of the UE upon rejection.

FIG. 2 illustrates a scenario where a PLMN is not allowed to operate at the present UE location according to some embodiments of the present disclosure.

In FIG. 2, the coverage of a PLMN, PLMN#1 is represented by an oval with left dashed lines, wherein four cells are included, i.e. Cell#1, Cell#2, Cell#3, and Cell#4. Within the coverage, there is a country, and the area of the country is represented by an irregular blank shape. Within this area, the PLMN#1 is not allowed to operate. In other words, the UE within the area of the country is not allowed to access to the cells of PLMN#1. A distance threshold is associated with the present location of the UE. Specifically, regarding the present location of the UE, the UE may not access to the cells of PLMN#1 within the distance threshold, i.e. the round area marked by right dashed lines. If the UE tries to access to PLMN#1, it may receive a reject message with cause value #78 “PLMNs not allowed to operate at the present UE location” from an NTN cell.

The list “PLMNs not allowed to operate at the present UE location” maintained by the NAS may include PLMN#1. The NAS behavior regarding the list may include:
Storing an PLMN in the list
   When NAS receives a reject message with cause value #78 “PLMNs not allowed to operate at the present UE location” from an NTN cell, that is, the UE cannot access to the PLMN. The NAS may store the PLMN in the list including the PLMN identity of the rejecting PLMN and the geographical location when rejected if known.
Timer maintaining for each PLMN
   The UE starts a timer instance associated with the PLMN with an implementation specific value, which shall not be set to a value smaller than the timer value indicated by the network if any.
Attempting access
   The UE is allowed to attempt to access a PLMN in the list when:
   1) distance from the geographical location when rejected to current UE location is larger than a UE implementation specific value, which shall not be set to a value smaller than the value indicated by the network if any; or
   2) the timer associated with the PLMN expires; or
   3) the access is for emergency services.
Removing a PLMN in the list
A PLMN may be removed if for the PLMN:
   1) distance from the geographical location when rejected to current UE location is larger than a UE implementation specific value; or
   2) the timer instance associated with the PLMN expires; or
   3) the UE successfully registers to the PLMN stored in the PLMN.
Keep or delete list
   When the UE is switched off, the UE shall keep the list of “PLMNs not allowed to operate at the present UE location” in its non-volatile memory. The UE shall delete the list of “PLMNs not allowed to operate at the present UE location” if the universal subscriber identity module (USIM) is removed.

It is observed that, although the list is maintained and used in the NAS, it may also impact the functions of the AS. For example, there are several issues regarding how to indicate the information associated with one or more PLMNs forbidden to operate at a present location of the UE, and how to apply the information.

Based on the list maintained in UE NAS, a UE at certain locations or in certain areas may be restricted to access to PLMNs in the list. However, there are several issues regarding the list as follows:

Issue#1: when and how to indicate the list of “PLMN not allowed to operate at the present UE location” and its associated information from the NAS to the AS need to be specified, to ensure that the AS has the latest list when necessary.

Currently, there is only one description: “maintaining the list is NAS function and NAS can indicate the list to AS”, while no further discussion on when and how the list may be indicated. Also, there is no associated information (e.g. time or distance thresholds) that determines its validity of the list. Considering potential impact or usage of the list in the AS (e.g. support of PLMN selection, cell searching or (re)selection), the present disclosure proposes some solutions for the AS to obtain the list and its associated information whenever it is needed, or whenever there is a change in the list.

Issue#2: when the AS determines available PLMNs to be reported to NAS for PLMN selection, it may either unnecessarily report a PLMN in the list, or miss an available PLMN not in the list.

In order to support PLMN selection, the AS may perform a search for available PLMNs and report them to NAS upon its request. With the list of “PLMN not allowed to operate at the present UE location” indicated from UE NAS to UE AS, it is unnecessary for the UE AS to report a found PLMN in the list.

Furthermore, for the licensed spectrum, the AS may search for the strongest cell and read its system information to know the PLMN it belongs to. For the shared spectrum (i.e., the unlicensed spectrum), the UE may search for multiple strongest cells to reduce possible failure of channel occupation. This is reasonable in the TN since different network operators typically own different licensed spectrums. However in an NTN, an operator may have both a TN and an NTN deployed with the same spectrum. Another case is that, when near country borders, the same spectrum may be used by different PLMNs on different sides of the border. As a result, searching for the strongest cell on a carrier may miss a cell belonging to an available PLMN that is not in the list. The present disclosure also provides solutions to solve the above issue for supporting the PLMN selection.

Issue#3: For a UE in IDLE state, a change in the list may also change the availability of serving or neighbour cells, and no mechanism for cell selection or reselection is defined to deal with such change.

According to the current mechanism, a PLMN can only be added to the list when UE receives a reject message with cause value #78. Under such assumption, a UE may enter or re-enter IDLE state upon reject while the signal of serving cell belonging to a PLMN in the list is still in good strength or quality, without triggering neighbour cell measurement as well as cell reselection to a cell belonging to a PLMN not in the list. If the UE finds a neighbour cell belonging to a PLMN in the list, the cell should not be considered as a candidate cell. In a special case when all found cells belong to PLMNs in the list, the UE encounters a coverage interruption similar to the discontinuous coverage scenario. In this case UE will keep cell scanning with unnecessary power consumption.

On the contrary, when a PLMN is removed from the list due to timer expiration or moving out of the distance, a UE in IDLE may not trigger neighbour cell measurement as well as cell reselection to a cell belonging to this PLMN in time. If the UE finds a neighbour cell belonging to the removed PLMN in the list, the cell should be considered as a candidate cell. In a special case when UE applies discontinuous coverage strategies including disabling cell scanning, it may not find coverage restore in time. The present disclosure proposes some solutions for solving the above issues.

The present disclosure relates to the NAS and the AS of a UE.

The NAS may include one or more protocol layers, which may include NAS Mobility Management (MM) and NAS Session Management (SM). The NAS may include a set of protocol of protocols in the evolved packet system (EPS). The NAS may be used to convey non-radio signalling between the UE and the mobility management entity (MME) for an LTE/E-UTRAN access. The NAS may also include a set of protocol of protocols in the 5G core network (5GC). The NAS may also be used to convey non-radio signalling between the UE and the access and mobility function (AMF) for an NR access. The NAS may include component(s), function(s), means(s), entity(s), instance(s), circuit(s), virtual device(s), logic(s) or the like, that can implement the set of protocols. In some other embodiments, the NAS may include component(s), function(s), means(s), entity(s), instance(s), circuit(s), virtual device(s), logic(s) or the like, that can implement the methods (or steps, operations, or the like) described in the present disclosure.

The NAS may be software, hardware, or a combination of software and hardware for implementing a dual-mode protocol stack that is used to setup and maintain communications between the device applications and the core network over one of the access networks. The NAS may include the non-access stratum software and any associated hardware for communicating with the core network. The NAS module may apply the wireless protocols necessary to interface the application layers with the core network.

The AS may also include one or more protocol layers, which may include RRC, PDCP, RLC, MAC and physical layers. The AS may include a set of protocol of protocols in the LTE system, the E-UTRAN system, or the NR system. The AS may include component(s), function(s), means(s), entity(s), instance(s), virtual device(s), logic(s) or the like, that can implement the set of protocols. In some other embodiments, the AS may include component(s), function(s), means(s), entity(s), instance(s), virtual device(s), logic(s) or the like, that can implement the methods (or steps, operations, or the like) described in the present disclosure.

The AS may include the access stratum software and any associated hardware for communicating with the radio access network.

In the present disclosure, the UE may include the NAS and the AS. The NAS may maintain a list of “PLMN not allowed at present UE location”. Each PLMN in the list may not be allowed to operate a certain area, and the NAS may transmit the list to the AS.

In addition to the list, the NAS may also include other information associated with one or more PLMNs forbidden to operate at a present location, and the information may be transmitted to the AS in some embodiments.

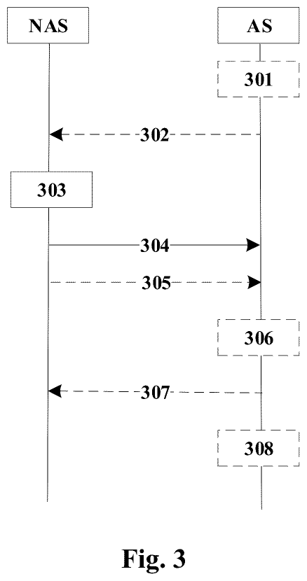

FIG. 3 illustrates a flow chart of transmitting the information associated with one or more PLMNs forbidden to operate at a present location of the UE from the NAS to the AS according to some embodiments of the present disclosure.

In operation 301, the AS may be triggered to transmit a request for the information associated with one or more PLMNs forbidden to operate at the present location of the UE. The trigger conditions may include at least one of the following:
Neighbour cell measurement for cell reselection is triggered in the AS;
Cell searching or cell scan for cell selection is triggered in the AS;
Cell ranking is triggered or performed in the AS; or
A cell is selected or reselected by the AS.

In operation 302, the AS may transmit a request message to the NAS, to request the information associated with one or more PLMNs forbidden to operate at the present location of the UE.

The information associated with one or more PLMNs forbidden to operate at the present location of the UE may include at least one of the following:
an identity of a PLMN that is not allowed to operate at a present location of the UE. For example, as shown in FIG. 2, the NAS may indicate the identity of the PLMN, e.g. PLMN#1, to AS.
a location of the UE where the UE receives a rejection from a PLMN indicating that the PLMN is not allowed to operate at the location of the UE. For example, as shown in FIG. 2, the NAS may indicate that the UE receives the rejection at the location of a boundary of country A.
validity time associated with one or more PLMNs in a list of PLMNs and associated epoch time. For example, as shown in FIG. 2, it is supposed that PLMN#1 may be valid from epoch time T₀, and will be valid for validity time T₁, the information may include the validity time T₁ and the associated epoch time To for PLMN#1.
   Upon receiving this information, the AS may start a timer TA associated to the PLMN or cells belonging to the PLMN with length determined based on the indicated validity time (i.e. T₁) and the corresponding its epoch time (i.e. T₀).
remaining validity time duration associated with one or more PLMNs in the list. For example, as shown in FIG. 2, it is supposed that PLMN#1 may be invalid in the next two hours (or any other value, for example, T₂), the information may include the remaining validity time duration with a value of two hours (or T₂).
   Upon receiving this information, the AS could start a timer TB associated to the PLMN or cells belonging to the PLMN with length of indicated remaining validity time (i.e. T₂).
distance thresholds associated with one or more PLMNs in the list and associated reference locations. For example, as shown in FIG. 2, the distance threshold is associated with PLMN#1 and the associated reference location is the location of the UE. The distance threshold suggests that in the case that the distance between the location of a UE and the reference location is less than or equal to the distance threshold, PLMN#1 cannot be accessed by the UE. In the case that the distance between the location of a UE and the reference location is greater than the distance threshold, PLMN#1 may be accessed by the UE.
an update of the list of PLMNs.
   The update of the list of PLMNs may include one or more PLMNs being removed from the list, one or more PLMNs being added to the list, or some configurations associated with one or more PLMNs being updated. For example, a new PLMN, such as PLMN#2 is added to the list of PLMNs. For another example, PLMN#1 is removed from the list of PLMNs. For still another example, the configuration, such as the remaining validity time associated with PLMN#1 may have changed.
an indication indicating reporting only allowed PLMNs.
   For example, the NAS may indicate the AS to report allowed PLMNs at the current location of the UE.

In some embodiments, the above information may have already been indicated to AS before, and the NAS may only transmit the information with changes compared to the previous transmitted information, i.e., delta indication. For instance, compared with the previously transmitted information, the change of the current information only includes adding a new PLMN, thus the NAS may only transmit the information related with this new PLMN to AS.

In operation 303, the NAS may determine whether a trigger condition for transmitting the information to the AS is fulfilled. For example, a request from the AS, which is performed in operation 302, is one of the trigger conditions. Upon receiving the request, the NAS may transmit the information to the AS.

In some cases, operation 301 and operation 302 may not exist, and the NAS may transmit the information associated with one or more PLMNs forbidden to operate at a present location of the UE in the case that at least one of the following trigger conditions is fulfilled:
one or more PLMNs being added to a list of PLMNs. For example, it is supposed that the list of PLMNs in FIG. 2 includes PLMN#1, and in the case that a new PLMN, such as PLMN#2 has been added to the list of PLMNs, the NAS may be triggered to transmit the information associated with PLMN#2 to the AS. Alternatively, the NAS may transmit all the information including both PLMN#1 and PLMN#2 to the AS.
one or more PLMNs being removed from the list. For example, in the case that PLMN#1 has been removed from the above list, the NAS may be triggered to transmit the information to the AS.
information associated with one or more PLMNs being updated. For example, the location of the UE, the distance threshold, the validity timer, the remaining validity time duration, etc. has been updated, and the NAS may be triggered to transmit the information to the AS.
a PLMN selection procedure or a PLMN reselection procedure. For example, the UE may need to perform a PLMN selection procedure or a PLMN reselection procedure, and the NAS may be triggered to transmit the information to the AS.
a periodic timer for transmitting the information being expired. For example, the NAS may transmit the information to the AS periodically, and a timer is maintained. Upon expiration of the timer, the NAS may be triggered to transmit the information to the AS.

In operation 304, the NAS may transmit, to the AS, the information associated with one or more PLMNs forbidden to operate at the present location of the UE.

In some embodiments, reporting to NAS for PLMN selection or PLMN reselection may be triggered by a request from the NAS, by the AS automatically, or by the AS periodically, then the AS may perform the PLMN selection procedure or the PLMN reselection procedure. For example, in operation 305, the NAS may transmit a request to the AS, for support of PLMN selection or PLMN reselection.

In operation 306, the NS may search for available PLMNs.

In the case that the cell with the strongest signal strength is associated with a PLMN in the list (for example, the cell is associated with a carrier belong to the PLMN), that is, the PLMN is not allowed to operate at a present location of the UE, the AS may search for the next N strongest cells on carrier(s), where N may be a preconfigured number. For example, there are M cells at the present location of the UE (M may be an a integer larger than N), among the M cells, cell₀ has the strongest signal strength, cell₁ has a signal strength lower than that of cell₀ but higher than any other cells, ... and cell_{M-1} has the lowest signal strength. Cell₀ is associated with a PLMN in the list, then the AS may search for the next N strongest cells, i.e. cell₁, cell₂, ..., cell_{N}. Alternatively, the AS may search for a number of cells with a signal strength higher than a preconfigured signal threshold. Suppose cell₁, cell₂ and cells have the signal strengths higher than the preconfigured signal threshold, and the AS may find cell₁, cell₂ and cell₃. The AS then may include the PLMN(s) associated with cell₁, cell₂, ..., and cell_{N}, or cell₁, cell₂, and cells and report the PLMN(s) to the NAS.

In some embodiments, in operation 306, during the PLMN selection procedure or the PLMN reselection procedure, the UE may determine available PLMNs by precluding or including a found PLMN based on the distance thresholds associated with the one or more PLMNs, the time thresholds associated with the one or more PLMNs, or both.

For example, for the first PLMN, in the case that the distance from a present location of the UE to a reference location associated with the first PLMN does not exceed a distance threshold of the first PLMN, the first PLMN may be considered as unavailable, and is precluded as an available PLMN. The AS may determine the location of the UE by trigger UE location acquiring procedures e.g., via global navigation satellite system (GNSS). On the other hand, in the case that the distance from a present location of the UE to a reference location associated with the first PLMN exceeds the distance threshold of the first PLMN, the first PLMN may be considered as available, and is included as an available PLMN. For example, according to FIG. 2, in the case that the distance from a present location of the UE to a reference location associated with the PLMN#1 does not exceed a distance threshold of the first PLMN, which means the UE may be within the area of country A, and PLMN#1 is not allowed to operate in the country, thus PLMN#1 may be considered as unavailable, and PLMN #1 is precluded as an available PLMN. In the case that the distance from a present location of the UE to a reference location associated with the PLMN#1 exceeds the distance threshold of the first PLMN, which means the UE may be out of the area of country A, and PLMN#1 is allowed to operate out of the area of country A, thus the UE may include PLMN#1, and PLMN#1 is included as an available PLMN.

Similarly, for the first PLMN, in the case that the time duration from a current time to an epoch time associated with the first PLMN to does not exceed a time threshold of the first PLMN, the first PLMN may be precluded. On the other hand, in the case that the time duration from a current time to an epoch time associated with the first PLMN to exceeds a time threshold of the first PLMN, the first PLMN may be considered as available, and is included as an available PLMN.

In some embodiments, during the PLMN selection procedure or the PLMN reselection procedure, the AS may receive an explicit indication from the NAS, which indicates the AS to report all found PLMNs, for example, for emergency services, the AS may ignore the information associated with one or more PLMN forbidden to operate at a present location of the UE, and report all found PLMNs.

In operation 307, the AS may transmit the available PLMNs found during the PLMN selection procedure or the PLMN reselection procedure to the NAS.

Operation 308 relates to some other cases, in particular, in the case that the information indicates a PLMN associated with a serving cell of the UE is not allowed to operate at a present location of the UE, the AS may perform at least one of the following:
trigger neighbour cell measurement;
perform cell selection or cell reselection to an available associated with a PLMN that is allowed to operate at a present location of the UE; or
enter an IDLE mode (e.g. RRC IDLE mode) in the case that the UE is in the CONNECTED mode (e.g. RRC CONNECTED mode) or the INACTIVE mode (e.g. RRC INACTIVE mode).

In some embodiments, when a cell selection procedure or a cell reselection procedure is triggered, the AS may preclude a cell associated with a PLMN that is not allowed to operate at a present location of the UE according to the information. Since the cell is associated with a PLMN that is not allowed to operate at a present location of the UE, the UE cannot access to the cell, thus the AS may preclude the cell during the cell selection procedure or the cell reselection procedure. On the other hand, the AS may determine a cell associated with a PLMN that is allowed to operate at a present location of the UE as a candidate cell according to the information. Since the cell is associated with a PLMN that is allowed to operate at a present location of the UE, the UE can access to the cell, thus the AS may select the cell during the cell selection procedure or the cell reselection procedure.

In some embodiments, in the case that all found neighbour cells belong to PLMNs not allowed to operate at a present location of the UE according to the information from the NAS, the AS may disable all cell searching or cell measurement. Since cell searching or cell measurement may be power consuming, it is reasonable for the AS to disable them when no cell is available. The AS may further transmit a message to the NAS, to request for entering sleep modes (which may include a power saving mode).

When all cell searching or cell measurement are disabled, and the NAS transmit information associated with one or more PLMNs forbidden to operate at a present location of the UE, which indicates that a PLMN is removed, i.e. there is a PLMN available or allowed to operate at a present location of the UE, the AS may enable cell searching or cell measurement. The AS may further transmit a message to the NAS, to request for quitting sleep modes (which may include power saving mode).

In should be noted that operations 301, 302, 305, 306, 307, and 308 are optional operations, they may be performed in certain embodiments, and may not be performed in other embodiments.

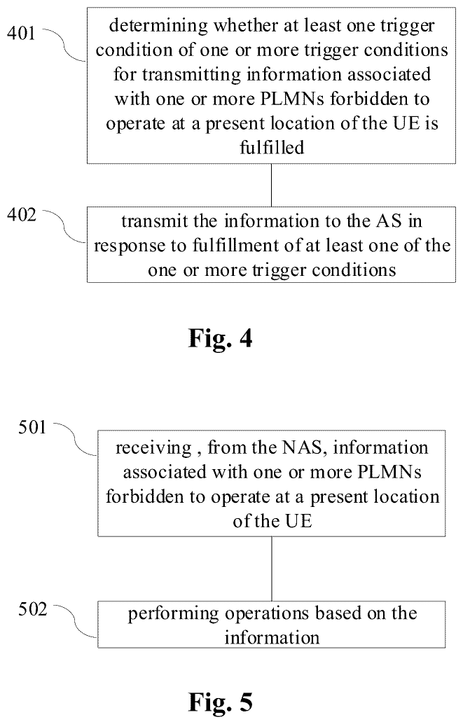

FIG. 4 illustrates a method performed by a NAS for transmitting the information associated with one or more PLMNs forbidden to operate at a present location of the UE from the NAS to the AS according to some embodiments of the present disclosure.

In operation 401, the NAS may determine whether at least one trigger condition of one or more trigger conditions for transmitting information associated with one or more PLMNs forbidden to operate at a present location of the UE is fulfilled. For example, the NAS may be triggered to transmit the information based on a request from the AS in operation 302. In operation 402, the NAS may transmit the information to the AS in response to fulfillment of at least one of the one or more trigger conditions.

In some embodiments, the information includes at least one of the following: an identity of a PLMN that is not allowed to operate at a present location of the UE; a location of the UE where the UE receives a rejection from a PLMN indicating that the PLMN is not allowed to operate at the location of the UE; validity time associated with one or more PLMNs in a list of PLMNs and associated epoch time; remaining validity time duration associated with one or more PLMNs in the list; distance thresholds associated with one or more PLMNs in the list and associated reference locations; an update of the list of PLMNs; or an indication indicating reporting only allowed PLMNs.

In some embodiments, the one or more trigger conditions includes at least one of the following: one or more PLMNs being added to a list of PLMNs; one or more PLMNs being removed from the list; information associated with one or more PLMNs being updated; a PLMN selection procedure; a PLMN reselection procedure; a request for the information from the UE AS; or a periodic timer for transmitting the information being expired.

In some embodiments, the NAS may receive one or more PLMNs associated with a first number of cells or a second number of cells from the AS, wherein a cell with a strongest signal strength is associated with a PLMN not allowed to operate at a present location of the UE based on the information, wherein each of the first number of cells is with a signal strength higher than a threshold, and wherein each of the second number of cells is with a signal strength lower than the strongest signal strength and higher than a signal strength of any unselected cells. For example, in operation 307, the NAS may receive N cells with a signal strength being lower than the cell with the strongest signal strength, but higher than the rest of the unselected cells.

FIG. 5 illustrates a method performed by an AS applying the information associated with one or more PLMNs forbidden to operate at a present location of the UE from the NAS to the AS according to some embodiments of the present disclosure.

In operation 501, the AS may receive, from the NAS, information associated with one or more PLMNs forbidden to operate at a present location of the UE. In operation 502, the AS may perform at least one of the following based on the information: perform PLMN selection or PLMN cell reselection; perform cell selection or cell reselection; enable cell searching or cell measurement; or disable cell searching or cell measurement.

In some embodiments, the AS may transmit, to the NAS, a request for the information at one of the following occasions: neighbour cell measurement for cell reselection is triggered; cell searching for cell selection is triggered; cell ranking is triggered; a cell is selected; or a cell is reselected.

In some embodiments, during the PLMN selection or PLMN cell reselection, in the case that a cell with a strongest signal strength is associated with a PLMN not allowed to operate at a present location of the UE based on the information, the AS may select a first number of cells each with a signal strength higher than a threshold, or select a second number of cells with signal strengths lower than the strongest signal strength and higher than a signal strength of any unselected cells; and transmit one or more PLMNs associated with the first number of cells or the second number of cells to the NAS. For example, in operation 306, the AS may select N cells with a signal strength being lower than the cell with the strongest signal strength, but higher than the rest of the unselected cells.

In some embodiments, during the PLMN selection or PLMN cell reselection, the AS may select one or more PLMNs based on at least one of the following: distance thresholds associated with the one or more PLMNs; time thresholds associated with the one or more PLMNs; or an indication indicating reporting all found PLMNs.

For example, the one or more PLMNs precludes a first PLMN in at least one of the following cases: a distance from a present location of the UE to a reference location associated with the first PLMN does not exceed a distance threshold of the first PLMN; or a time duration from a current time to an epoch time associated with the first PLMN to does not exceed a time threshold of the first PLMN. On the other hand, the one or more PLMNs includes a second PLMN in at least one of the following cases: a distance from a present location of the UE to a reference location associated with the second PLMN exceeds a distance threshold of the second PLMN; or a time duration from a current time to an epoch time associated with the second PLMN to exceeds a time threshold of the second PLMN.

For example, as shown in FIG. 2, in the case that a distance from a present location of the UE to a reference location associated with PLMN#1 does not exceed a distance threshold of the PLMN#1, the UE may be within the area with right dashed lines, i.e. within the area that may not access to the PLMN#1, thus PLMN#1 is not an available PLMN, thus is precluded. In the case that the distance exceeds the distance threshold of the PLMN#1, PLMN#1 is an available PLMN, thus is included.

In some embodiments, in the case that the information indicates a PLMN associated with a serving cell of the UE is not allowed to operate at a present location of the UE, the AS is further configured to perform at least one of the following: trigger neighbour cell measurement; perform cell selection or cell reselection to a cell associated with a PLMN that is allowed to operate at a present location of the UE; or enter an IDLE mode.

In some embodiments, the AS may precluding a cell associated with a PLMN that is not allowed to operate at a present location of the UE according to the information; or determine a cell associated with a PLMN that is allowed to operate at a present location of the UE as a candidate cell according to the information.

In some embodiments, the AS may disable all cell searching or cell measurement in the case that all neighbour cell(s) of the UE is associated with one or more PLMNs that are not allowed to operate at a present location of the UE according to the information.

In some embodiments, the AS may enable cell searching or cell measurement in the case that one or more neighbour cells associated with one or more PLMNs allowed to operate at a present location of the UE according to the information.

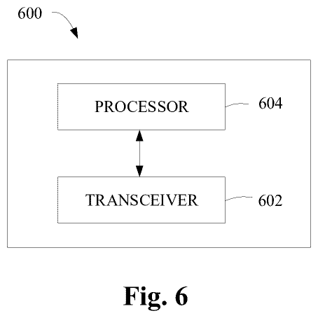

FIG. 6 illustrates a simplified block diagram of an exemplary apparatus according to some embodiments of the present disclosure.

As shown in FIG. 6, an example of the apparatus 600 may include at least one processor 604 and at least one transceiver 602 coupled to the processor 604. The apparatus 600 may be a UE or any other device with similar functions. In some embodiments, the apparatus 600 may include a NAS or an AS (not shown in FIG. 6). The NAS or AS may be in the form of component(s), function(s), means(s), entity(s), instance(s), circuit(s), virtual device(s), logic(s) or the like, that can implement the set of protocols.

Although in this figure, elements such as the at least one transceiver 602 and processor 604 are described in the singular, the plural is contemplated unless a limitation to the singular is explicitly stated. In some embodiments of the present disclosure, the transceiver 602 may be divided into two devices, such as a receiving circuitry and a transmitting circuitry. In some embodiments of the present disclosure, the apparatus 600 may further include an input device, a memory, and/or other components.

In some embodiments of the present disclosure, the apparatus 600 may be a UE. The transceiver 602 and the processor 604 may interact with each other so as to perform the operations of the UE described in any of FIGS. 1-5.

In some embodiments of the present disclosure, the apparatus 600 may further include at least one non-transitory computer-readable medium.

For example, in some embodiments of the present disclosure, the non-transitory computer-readable medium may have stored thereon computer-executable instructions to cause the processor 604 to implement the method with respect to the UE as described above. For example, the computer-executable instructions, when executed, cause the processor 604 interacting with transceiver 602 to perform the operations of the UE described in any of FIGS. 1-5.

In some embodiments of the present disclosure, the non-transitory computer-readable medium may have stored thereon computer-executable instructions to cause the processor 604 to implement the method with respect to the node as described above. For example, the computer-executable instructions, when executed, cause the processor 604 interacting with transceiver 602 to perform the operations of the node described in any of FIGS. 1-5.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
least one processor coupled with the at least one memory and configured to cause the UE to:
determine, via non-access stratum (NAS), whether at least one trigger condition of one or more trigger conditions for transmitting information associated with one or more public land mobile networks (PLMNs) forbidden to operate at a present location of the UE is fulfilled; and
transmit the information to an access stratum (AS) in response to fulfillment of at least one of the one or more trigger conditions.

2. The UE of claim 1, wherein the information includes at least one of the following:
an identity of a PLMN that is not allowed to operate at a present location of the UE;
a location of the UE where the UE receives a rejection from a PLMN indicating that the PLMN is not allowed to operate at the location of the UE;
validity time associated with one or more PLMNs in a list of PLMNs and associated epoch time;
remaining validity time duration associated with one or more PLMNs in the list;
distance thresholds associated with one or more PLMNs in the list and associated reference locations;
an update of the list of PLMNs; or
an indication indicating reporting only allowed PLMNs.

3. The UE of claim 1, wherein the one or more trigger conditions includes at least one of the following:
one or more PLMNs being added to a list of PLMNs;
one or more PLMNs being removed from the list;
information associated with one or more PLMNs being updated;
a PLMN selection procedure;
a PLMN reselection procedure;
a request for the information from the UE-AS; or
a periodic timer for transmitting the information being expired.

4. The UE of claim 1, wherein the at least one processor is further configured to cause the UE to:
receive one or more PLMNs associated with a first number of cells or a second number of cells from the AS, wherein a cell with a strongest signal strength is associated with a PLMN not allowed to operate at a present location of the UE based on the information, wherein each of the first number of cells is with a signal strength higher than a threshold, and wherein each of the second number of cells is with a signal strength lower than the strongest signal strength and higher than a signal strength of any unselected cells.

5. A user equipment (UE) for wireless communication, comprising:
at least one memory; and
at least one processor coupled with the at least one memory and configured to cause the UE:
receive, by an access stratum (AS) and from a non-access stratum (NAS), information associated with one or more public land mobile networks (PLMNs) forbidden to operate at a present location of the UE; and
perform at least one of the following based on the information:
perform PLMN selection or PLMN cell reselection;
perform cell selection or cell reselection;
enable cell searching or cell measurement; or
disable cell searching or cell measurement.

6. The UE of claim 5, wherein the information includes at least one of the following:
an identity of a PLMN that is not allowed to operate at a present location of the UE;
a location of the UE where the UE receives a rejection from a PLMN indicating that the PLMN is not allowed to operate at the location of the UE;
validity time associated with one or more PLMNs in a list of PLMNs and associated epoch time;
remaining validity time duration associated with one or more PLMNs in the list;
distance thresholds associated with one or more PLMNs in the list and associated reference locations;
an update of the list of PLMNs; or
an indication indicating reporting only allowed PLMNs.

7. The UE of claim 5, wherein the at least one processor is further configured to cause the UE to:
transmit, from the AS to the NAS, a request for the information at one of the following occasions:
neighbor cell measurement for cell reselection is triggered;
cell searching for cell selection is triggered;
cell ranking is triggered;
a cell is selected; or
a cell is reselected.

8. The UE of claim 5, wherein performing PLMN selection or PLMN cell reselection includes:
when a cell with a strongest signal strength is associated with a PLMN not allowed to operate at a present location of the UE based on the information, selecting a first number of cells each with a signal strength higher than a threshold, or selecting a second number of cells with signal strengths lower than the strongest signal strength and higher than a signal strength of any unselected cells; and
transmitting one or more PLMNs associated with the first number of cells or the second number of cells to the NAS.

9. The UE of claim 5, wherein performing PLMN selection or PLMN cell reselection includes:
selecting one or more PLMNs based on at least one of the following:
distance thresholds associated with the one or more PLMNs;
time thresholds associated with the one or more PLMNs; or
an indication indicating reporting all found PLMNs.

10. The UE of claim 9, wherein the one or more PLMNs precludes a first PLMN in at least one of the following cases:
a distance from a present location of the UE to a reference location associated with the first PLMN does not exceed a distance threshold of the first PLMN; or
a time duration from a current time to an epoch time associated with the first PLMN to does not exceed a time threshold of the first PLMN.

11. The UE of claim 9, wherein the one or more PLMNs includes a second PLMN in at least one of the following cases:
a distance from a present location of the UE to a reference location associated with the second PLMN exceeds a distance threshold of the second PLMN; or
a time duration from a current time to an epoch time associated with the second PLMN to exceeds a time threshold of the second PLMN.

12. The UE of claim 5, wherein, when the information indicates a PLMN associated with a serving cell of the UE is not allowed to operate at a present location of the UE, the at least one processor is further configured to cause the UE to perform at least one of the following via the AS:
trigger neighbor cell measurement;
perform cell selection or cell reselection to a cell associated with a PLMN that is allowed to operate at a present location of the UE; or
enter an IDLE mode.

13. The UE of claim 5, wherein performing cell selection or cell reselection includes at least one of the following:
precluding a cell associated with a PLMN that is not allowed to operate at a present location of the UE according to the information; or
determining a cell associated with a PLMN that is allowed to operate at a present location of the UE as a candidate cell according to the information.

14. The UE of claim 5, wherein disabling cell searching or cell measurement includes:
disabling all cell searching or cell measurement in the case that all neighbor cells of the UE is associated with one or more PLMNs that are not allowed to operate at a present location of the UE according to the information.

15. A method performed by a user equipment (UE), the method comprising:
determining whether at least one trigger condition of one or more trigger conditions for transmitting information associated with one or more public land mobile networks (PLMN) forbidden to operate at a present location of a user equipment (UE) is fulfilled; and
transmitting the information in response to fulfillment of at least one of the one or more trigger conditions.

16. The method of claim 15, wherein the information includes at least one of the following:
an identity of a PLMN that is not allowed to operate at a present location of the UE;
a location of the UE where the UE receives a rejection from a PLMN indicating that the PLMN is not allowed to operate at the location of the UE;
validity time associated with one or more PLMNs in a list of PLMNs and associated epoch time;
remaining validity time duration associated with one or more PLMNs in the list;
distance thresholds associated with one or more PLMNs in the list and associated reference locations;
an update of the list of PLMNs; or
an indication indicating reporting only allowed PLMNs.

17. The method of claim 16, wherein the one or more trigger conditions includes at least one of the following:
one or more PLMNs being added to a list of PLMNs;
one or more PLMNs being removed from the list;
information associated with one or more PLMNs being updated;
a PLMN selection procedure;
a PLMN reselection procedure;
a request for the information from the AS; or
a periodic timer for transmitting the information being expired.

18. The method of claim 15, further comprising:
receiving one or more PLMNs associated with a first number of cells or a second number of cells from the AS, wherein a cell with a strongest signal strength is associated with a PLMN not allowed to operate at a present location of the UE based on the information, wherein each of the first number of cells is with a signal strength higher than a threshold, and wherein each of the second number of cells is with a signal strength lower than the strongest signal strength and higher than a signal strength of any unselected cells.

19. A processor for wireless communication, comprising:
at least one controller coupled with the at least one memory and configured to cause the processor to:
receive, by an access stratum (AS) and from a non-access stratum (NAS), information associated with one or more public land mobile networks (PLMNs) forbidden to operate at a present location of the processor; and
perform at least one of the following based on the information:
perform PLMN selection or PLMN cell reselection;
perform cell selection or cell reselection;
enable cell searching or cell measurement; or
disable cell searching or cell measurement.

20. The processor of claim 19, wherein the information includes at least one of the following:
an identity of a PLMN that is not allowed to operate at a present location of the UE;
a location of the processor where the processor receives a rejection from a PLMN indicating that the PLMN is not allowed to operate at the location of the processor;
validity time associated with one or more PLMNs in a list of PLMNs and associated epoch time;
remaining validity time duration associated with one or more PLMNs in the list;
distance thresholds associated with one or more PLMNs in the list and associated reference locations;
an update of the list of PLMNs; or
an indication indicating reporting only allowed PLMNs.
